(19) United States
(12) Patent Application Publication
(10) Pub. No.: US 2015/0071562 A1
(43) Pub. Date: Mar. 12, 2015

(54) IMAGE PROCESSING APPARATUS

(71) Applicant: Kei YASUTOMI, Tokyo (JP)

(72) Inventor: Kei YASUTOMI, Tokyo (JP)

(73) Assignee: RICOH COMPANY, LIMITED., Tokyo (JP)

(21) Appl. No.: 14/475,713

(22) Filed: Sep. 3, 2014

(30) Foreign Application Priority Data
Sep. 11, 2013 (JP) 2013-188810

(51) Int. Cl. G06T 5/00; G06T 5/10

(52) U.S. Cl. CPC G06T 5/002; G06T 5/10
USPC 382/264

(57) ABSTRACT

An image processing apparatus includes: a first smoothing unit that outputs a first smoothed image by using a first edge-preserving smoothing filter to an input image; a second smoothing unit that outputs a second smoothed image by further using a second edge-preserving smoothing filter to the first smoothed image output by the first smoothing unit; a correction data derivation unit that derives a difference between the first and second smoothed images as correction data; and a correcting unit that corrects the input image based on the correction data.

### CROSS-REFERENCE TO RELATED APPLICATIONS

The present application claims priority to and incorporates by reference the entire contents of Japanese Patent Application No. 2013-188810 filed in Japan on Sep. 11, 2013.

### BACKGROUND OF THE INVENTION

1. Field of the Invention

The present invention relates to an image processing apparatus.

2. Description of the Related Art

Traditionally, image processing for changing unevenness and three-dimensional appearance of an image has been performed. For example, a so-called 3D image technology which provides a three-dimensional image by using binocular parallax of an observer has been known.

For example, JP 5147287 B1 discloses an image processing apparatus which estimates a normal direction for each region from brightness information and obtains a correction amount of the brightness information by obtaining a normal direction vector for each region, and thereby improves depth feeling and three-dimensional appearance in the processed image.

Also, JP 4556276 B1 discloses an image processing circuit which generates a gain correction coefficient to correct a pixel value of an input image by storing an edge of the input image and performing smoothing to the pixel value and corrects the pixel value of the input image according to the gain correction coefficient.

Also, JP 06-217090 A discloses image reading device which estimates a three-dimensional shape of a manuscript by using reflectance distribution and illumination light intensity and corrects geometric distortion of an image data generated by inclination of a surface of the manuscript based on the estimated three-dimensional shape.

However, in the related art, there have been problems, i.e., a problem in that the image processing apparatus cannot appropriately act when a plurality of lightings exists and a problem in that illumination detection accuracy may be largely deteriorated when an illumination direction partially changes.

In view of the above, there is a need to provide an image processing apparatus which can improve unevenness and three-dimensional appearance of an image even when a plurality of lightings exists with respect to the image.

### SUMMARY OF THE INVENTION

It is an object of the present invention to at least partially solve the problems in the conventional technology.

An image processing apparatus includes: a first smoothing unit that outputs a first smoothed image by using a first edge-preserving smoothing filter to an input image; a second smoothing unit that outputs a second smoothed image by further using a second edge-preserving smoothing filter to the first smoothed image output by the first smoothing unit; a correction data derivation unit that derives a difference between the first and second smoothed images as correction data; and a correcting unit that corrects the input image based on the correction data.

An image processing apparatus includes: a first smoothing unit that outputs a first smoothed image by using a first edge-preserving smoothing filter to an input image; a second smoothing unit that outputs a second smoothed image by using a second edge-preserving smoothing filter that performs smoothing in a wider range than the first edge-preserving smoothing filter, to the input image; a correction data derivation unit that derives a difference between the first and second smoothed images as correction data; and a correcting unit that corrects the input image based on the correction data.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a configuration of an image processing apparatus according to a first embodiment;

FIG. 2 is a graph of a conversion characteristic from V_{M}(x, y) to V′_{M}(x, y);

FIG. 3 is a graph of a conversion characteristic from V_{M}(x, y) to V′_{M}(x, y) of a third modification of the image processing apparatus;

FIG. 4 is a graph of coefficients; and

FIG. 5 is a block diagram of a configuration of an image processing apparatus according to a second embodiment.

### DETAILED DESCRIPTION OF THE PREFERRED EMBODIMENTS

Embodiments of an image processing apparatus will be described in detail below with reference to the drawings.

### First Embodiment

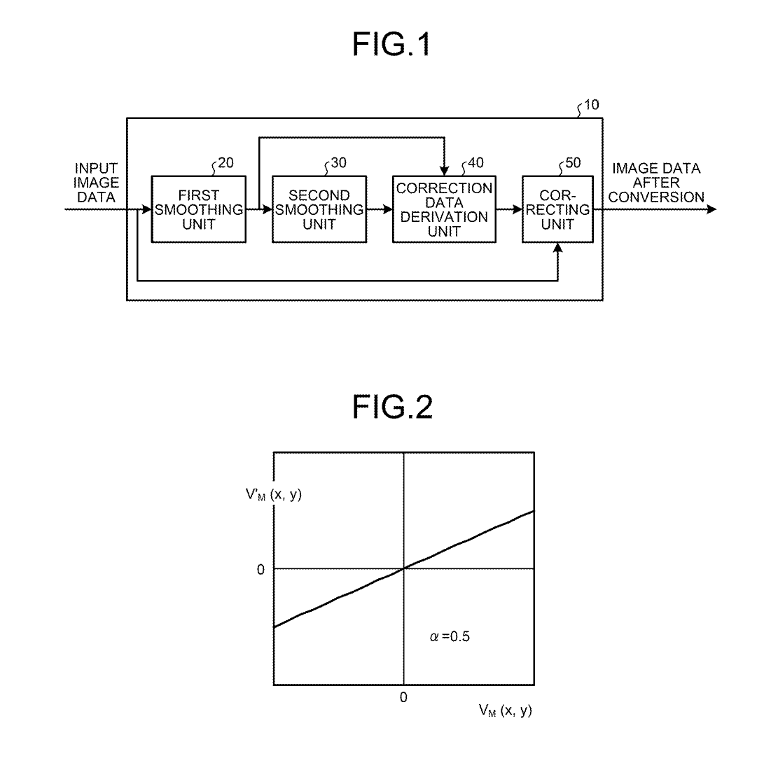

FIG. 1 is a block diagram of a configuration of an image processing apparatus 10 according to a first embodiment. First, an outline of the image processing apparatus 10 will be described. As illustrated in FIG. 1, the image processing apparatus 10 includes a first smoothing unit 20, a second smoothing unit 30, a correction data derivation unit 40, and a correcting unit 50. Each unit of the image processing apparatus 10 may include hardware and software executed by a CPU not illustrated.

The image processing apparatus 10 receives image data in a general format (input image data) as an input image. The first smoothing unit 20 calculates an image data (first smoothed image) in which a first edge-preserving smoothing filter has been applied to the input image data. The second smoothing unit 30 calculates an image data (second smoothed image) in which a second edge-preserving smoothing filter has been applied to the output result of the first smoothing unit 20 (first smoothed image).

The correction data derivation unit 40 calculates correction data by obtaining a difference per pixel between the first and second smoothed images. The correcting unit 50 calculates and outputs an image after conversion (image data after conversion) to be an output image by adding the correction data calculated by the correction data derivation unit 40 to the input image data per pixel.

The input image data is in TIF format and has three color components of RGB. The input image data has 16-bit data of each color per pixel. A file format of the input image data is not limited to the TIF format and may be other file formats such as JPEG and PNG. Also, a color component is not limited to a RGB color space and may be a color space other than the RGB. A data amount per pixel may also be other than 16 bits.

Next, the first smoothing unit 20 will be described in detail. The first smoothing unit 20 applies the edge-preserving smoothing filter to a color image and performs the smoothing. Here, the edge-preserving smoothing filter is a bilateral filter indicated by formulas (1) and (2) below.

The input image is two-dimensional image data. Therefore, position coordinates of each pixel are expressed by x and y. Also, since the input image is the color image having three color components of the RGB in each pixel, the input image is expressed as a three-dimensional vector.

$$\vec{g} ( x , y ) = {k}^{- 1} {\sum }_{n = - w}^{w} {\sum }_{m = - w}^{w} \vec{f} ( x + m , y + n ) \times exp [ - \frac{{m}^{2} + {n}^{2}}{2 {σ}_{1}^{2}} ] \times exp [ - \frac{{\vert \vec{f} ( x + m , y + n ) - \vec{f} ( x , y ) \vert}^{2}}{2 {σ}_{2}^{2}} ] \qquad ( 1 )$$

x, y: x-coordinate and y-coordinate for representing pixel position of two-dimensional image data (integer number)
m, n: x-coordinate and y-coordinate for representing filter position (integer number)
W: maximum and minimum values of the above-mentioned m and n (filter size becomes 2W+1)
\vec{g}(x, y): value in position of image after bilateral filter processing (x, y) (\vec{g} is three-dimensional vector and respective components of vector corresponds to RGB values which represent three color components of color image)
\vec{f}(x, y): value in position of input image (image before processing) (x, y) (\vec{f} is three-dimensional vector and respective components of vector correspond to RGB values which represent three color components of color image)
   |\vec{f}(x+m, y+n)−\vec{f}(x, y)|²: square of absolute value of vector difference (sum of squares differences of respective components of vectors)
σ₁: standard deviation 1 (value for characterizing weighting by distance in x and y directions)
σ₂: standard deviation 2 (value for characterizing weighting by distance between colors)
k: term to make a sum of weights by smoothing 1 (average values of \vec{g}(x, y) and \vec{f}(x, y) becomes constant)

$$k = {\sum }_{n = - w}^{w} {\sum }_{m = - w}^{w} exp [ - \frac{{m}^{2} + {n}^{2}}{2 {σ}_{1}^{2}} ] \times exp [ - \frac{{\vert \vec{f} ( x + m , y + n ) - \vec{f} ( x , y ) \vert}^{2}}{2 {σ}_{2}^{2}} ] \qquad ( 2 )$$

The first smoothing unit 20 uses 30 [pixel] as a value of a standard deviation σ1. This is on the assumption that a resolution in a case where the input image is printed or displayed be 400 [dpi]. When it is assumed that the input image be printed or displayed at a lower resolution than 400 [dpi], it is preferable to adjust the value of the standard deviation σ1 according to the resolution. For example, in a case where the input image is displayed on a display such as a normal PC having the resolution of 100 [dpi], it is preferable that the value of the standard deviation σ1 be 7.5 [pixel].

It is assumed that the value of the standard deviation σ1 of the first smoothing unit 20 be the above value. However, in a case where it is assumed that the resolution be 400 [dpi] as described above, an appropriate range of the value of the standard deviation σ1 is from 15 to 60 [pixel]. A reason why such a range is appropriate will be described below.

The first smoothing unit 20 has a function to remove a high frequency component by the smoothing. In order to realize the improvement in the unevenness and three-dimensional appearance, it is necessary to emphasize a specific frequency component. According to the study by the inventor, it has been found that, especially, a frequency component of 0.1 to 1.0 [cycle/mm] as the specific frequency component is effective. Therefore, by setting the value of the standard deviation σ1 to be in the above range (of 15 to 60 [pixel]), a spatial frequency component corresponding to a spatial frequency larger than 1.0 [cycle/mm] in rough estimation can be removed in a case where it is assumed that the resolution of the input image be 400 dpi.

Also, the first smoothing unit 20 uses 0.2 (standardized value) as a value of a standard deviation σ2. The above value of 0.2 is applied when the respective components expressing three color components of the input image f(x, y) are standardized to have values of 0 to 1.0. When the range of each color component of the input image is not from 0 to 1 and the input image is 16-bit without being standardized and directly uses a value of 0 to 65535, for example, the value of the standard deviation σ2 is appropriately changed corresponding thereto.

The first smoothing unit 20 uses the above value (0.2) as the value of the standard deviation σ2, but an appropriate range of the value of the standard deviation σ2 is from 0.03 to 0.4. When performing averaging operation of the pixels, the standard deviation σ2 acts such that a weight becomes smaller as the concentration difference becomes larger.

Here, it is appropriate that a value corresponding to the concentration difference recognized as an edge be employed as the value of the standard deviation σ2 in order to avoid the averaging operation in the vicinity of the edge having a large concentration difference (averaging operation over the edge). According to the study by the inventor, the value of the standard deviation σ2 suitable for a wide range of input images is from 0.03 to 0.4. By setting such a value as the value of the standard deviation σ2, a smoothing operation in the vicinity of the edge can be avoided and an image to which the smoothing operation has been performed only in the range other than the vicinity of the edge can be generated.

In the first smoothing unit 20, it is assumed that a value W (maximum/minimum values of m and n) in the formulas (1) and (2) be 96 [pixel]. Although there is no problem when the value W is larger than 96 [pixel], this causes the values m and n to be larger. However, the second term almost becomes zero and thus contribution to the smoothing operation is eliminated when the values of m and n are large. In the first smoothing unit 20, the standard deviation σ1 is set to be 30 [pixel]. In this case, 96 [pixel] is appropriate as the value of W, and the result is little changed even when the value equal to or more than 96 [pixel] is selected.

The first smoothing unit 20 applies the edge-preserving filter according to the bilateral filter expressed by the above described calculation formula, to the input image (color image) and calculates “first smoothed image” which is a processing result.

The first smoothing unit 20 employs a bilateral filter as the edge-preserving smoothing filter. However, the edge-preserving smoothing filter may be other than the bilateral filter. For example, an ε filter disclosed in JP 4556276 B1, a Non-Local Means filter, or the like may be used.

Next, the second smoothing unit 30 will be described in detail. The second smoothing unit 30 applies the edge-preserving smoothing filter for the color image, to the above-mentioned “first smoothed image” similarly to the first smoothing unit 20 and performs the smoothing. The edge-preserving smoothing filter used by the second smoothing unit 30 is also the bilateral filter which has been described with reference to the above-mentioned formulas (1) and (2). A difference between the bilateral filters used by the second smoothing unit 30 and the above-mentioned first smoothing unit 20 is that parameters to be used are different.

The second smoothing unit 30 uses 90 [pixel] as the value of the standard deviation σ1. This is on the assumption that the resolution in a case where the input image is printed or displayed be 400 [dpi] similarly to the description regarding the first smoothing unit 20. When the input image is displayed on the display such as the normal PC having the resolution of 100 [dpi], it is preferable to use 22.5 [pixel] as the value of the standard deviation σ1.

The second smoothing unit 30 uses the above value as the value of the standard deviation σ1, and the appropriate range of the value of the standard deviation σ1 is from 45 to 180 [pixel]. A reason why such a range is appropriate will be described next.

The second smoothing unit 30 has a function to extract the specific frequency component when obtaining a difference between an image to which the processing is performed by the second smoothing unit 30 and the first smoothed image. Here, it has been found according to the study by the inventor that the frequency component especially in a range of 0.1 to 1.0 [cycle/mm] is effective as the specific frequency component in order to realize an improvement in the unevenness and three-dimensional appearance.

By setting the value of the standard deviation σ1 of the second smoothing unit 30 in the above-mentioned range (45 to 180 [pixel]), the spatial frequency component corresponding to the spatial frequency smaller than 0.1 [cycle/mm] in rough estimation when it is assumed that the resolution of the input image be 400 dpi. Therefore, a component in a target frequency region can be extracted as the specific frequency component by obtaining the difference between the image to which the processing is performed by the second smoothing unit 30 and the first smoothed image.

The second smoothing unit 30 uses 0.2 (standardized value) as the value of the standard deviation σ2 similarly to the first smoothing unit 20. The above value of 0.2 is applied when the respective color components expressing the three color components of the input image f(x, y) are standardized to have values of 0 to 1.0.

The second smoothing unit 30 uses the above value as the value of the standard deviation σ2, but an appropriate range of the value of the standard deviation σ2 is from 0.03 to 0.4. For the reason similar to that in the description regarding the first smoothing unit 20, an appropriate value of the standard deviation σ2 to avoid the influence of the edge in a wide range of input images has been from 0.03 to 0.4. Therefore, with respect to the second smoothed image, the same range of the value of the standard deviation σ2 as that of the first smoothing unit 20 is applied. By setting such a value as the value of the standard deviation σ2, a smoothing operation in the vicinity of the edge can be avoided and an image to which the smoothing operation has been performed only in the region other than the vicinity of the edge can be generated.

The second smoothing unit 30 applies the edge-preserving filter according to the bilateral expressed by the above-mentioned calculation formula, to the “first smoothed image” and calculates the “second smoothed image” which is the processing result. In the second smoothing unit 30, a filter other than the bilateral filter may be used as the edge-preserving smoothing filter.

Next, the correction data derivation unit 40 will be described in detail. The correction data derivation unit 40 calculates an image, in which the specific frequency component is extracted, by obtaining a difference between the above-mentioned “first smoothed image” and “second smoothed image”. Here, the specific frequency component only in the brightness component is extracted by obtaining a difference between only the brightness components of the “first smoothed image” and the “second smoothed image” which are color images. Calculation formulas used by the correction data derivation unit 40 will be described below.

The correction data derivation unit 40 converts the color space for the “first smoothed image” first. The “first smoothed image” is image data expressed in a RGB color space having the color components of the RGB as the three color components. In order to extract only the brightness component, the “first smoothed image” is converted into an HSV color space. The correction data derivation unit 40 performs the conversion to the HSV color space according to formulas (3) to (5).

$$\begin{matrix}V ← max ( R , G , B ) & ( 3 ) \\ S ← \{ \begin{matrix}\frac{V - min ( R , G , B )}{V} & if V \neq 0 \\ 0 & otherwise\end{matrix} & ( 4 ) \\ H ← \{ \begin{matrix}60 ( G - B ) / S & if V = R \\ 120 + 60 ( B - R ) / S & if V = G \\ 240 + 60 ( R - G ) / S & if V = B\end{matrix} & ( 5 )\end{matrix}$$

The image processing apparatus 10 converts the “first smoothed image” into the HSV color space according to the formulas (3) to (5). A V component of the “first smoothed image” converted into the HSV color space is expressed by V₁(x, y).

Similarly, the “second smoothed image” is converted into the HSV color space according to the formulas (3) to (5). A V component of the “second smoothed image” converted into the HSV color spaces is expressed by V₂(x, y).

The correction data derivation unit 40 calculates the correction data by obtaining a difference between the V components of the first and second smoothed images. A calculation formula of the correction data is a formula (6) below, and each position of the image data is indicated by the difference between the V components of the first and second smoothed images.

V_{M}(x,y)=V₁(x,y)−V₂(x,y) (6)

V_{M}(x, y): correction data

V₁(x, y): V component of first smoothed image

V₂(x, y): V component of second smoothed image

The correction data derivation unit 40 calculates “correction data” which is a processing result by performing the processing expressed by the calculation formulas (3) to (6). The correction data derivation unit 40 uses color space conversion into the HSV color space to extract only the brightness component of the image. However, another color space may be used to extract the brightness component. For example, a Lab color space may be used.

Next, the correcting unit 50 will be described in detail. The correcting unit 50 calculates the output image which is the data after the conversion by adding the above-mentioned “correction data” to the input image. The correcting unit 50 performs color conversion according to the formulas (3) to (5) on the input image first to convert it into a color image data in the HSV color space. Only to the brightness component of the input image converted into the HSV color space in this way, the “correction data” calculated by the above-mentioned formula (6) is added. A calculation formula used by the correcting unit 50 will be described below.

V′(x,y)=V(x,y)+V_{M}(x,y) (7)

V′(x, y): V component of data after conversion

V(x, y): V component of input image

V_{M}(x, y): correction data

H′(x,y)=H(x,y) (8)

H′(x, y): H component of data after conversion

H(x, y): H component of input image

S′(x,y)=S(x,y) (9)

S′(x, y): S component of data after conversion

S(x, y): S component of input image

Each component of the input image in the HSV color space is calculated by applying the formulas (3) to (5) to the input image.

The correcting unit 50 calculates the output image which is the data after the conversion by performing the conversion (reverse conversion) from the HSV color space into the RBG color space, on the HSV component after the conversion obtained by formulas (7) to (9). The conversion from the HSV color space into the RGB color space corresponds to the reverse conversion of the formulas (3) to (5).

According to the study by the inventor, the image can be converted into the image having the improved unevenness and three-dimensional appearance by emphasizing the specific frequency component of the image (especially, low frequency component). However, when specific frequency component is simply emphasized, a problem occurs in that an emphasis on a part, where the concentration change is small, in the vicinity of the edge is perceived and a sense of incongruity is felt.

The emphasis of the specific frequency component of the image in this way is equivalent to an operation of generating image data by extracting only the specific frequency component and returning the extracted data from a frequency space to a real space and adding the image data to the input image (add a data value for each pixel).

As a supplement, in order to improve the unevenness and three-dimensional appearance, it is preferable to emphasize a lower frequency component of the above-mentioned specific frequency component (here, lower frequency component indicates the spatial frequency component of 0.01 to 1.0 [cycle/mm] in rough estimation). However, the emphasis of the low frequency component means that the effect of the problem generated in the part, where the concentration change is small, in the vicinity of the edge reaches far away. Therefore, a sense of incongruity is felt in a wide area, and the above problem becomes more easy to be perceived.

Also, in a case where the specific frequency component is simply emphasized, a part like the edge where the concentration change is larger has a larger amount of the change caused by the emphasis (a difference between the input image and a converted image by the emphasis becomes larger) (amount of the change from the input image generated by the emphasis inevitably becomes larger in the vicinity of the edge).

On the other hand, the concentration change of the input image in an area, on which it is essentially preferable to emphasize, related to the unevenness and the three-dimensional appearance is smaller than that in the edge region. Therefore, the amount of the change generated by the emphasis of the specific frequency component is comparatively small in a region other than the edge. This causes a negative effect on the generation of a sense of incongruity in the vicinity of the edge. That is, with the simple emphasis of the specific frequency component, the amount of the change caused by the emphasis becomes larger in the vicinity of the edge when the edge having the large concentration difference exists in the image.

The inventor has pursued a method to realize both the improvement in the unevenness and three-dimensional appearance and the solution of the problem in the vicinity of the edge. As a result, the inventor has found that the input image can be converted into an image having an improved “texture” in terms of “texture” of an object such as the unevenness and the three-dimensional appearance. Coexistent with this, the problem can be solved that the emphasis performed in the part, where the concentration change is small, in the vicinity of the edge is perceived, the problem occurring when the specific frequency component is simply emphasized.

According to this effect of the image processing apparatus 10, the image data having senses of presence and reality of the object can be obtained. Also, the unevenness and the three-dimensional appearance of the object is allowed to be adjusted according to a purpose and a target of an image user. Accordingly, when the image data obtained by the image processing apparatus 10 is used for a product advertisement or the like, an advertisement having great appeal of the product and high attention of customers can be obtained. Of course, the image data having the senses of the presence and reality of the object can be applied to various purposes other than the product advertisement.

The inventor considers a reason why the problem in that the emphasis performed in the part, where the concentration change is small, in the vicinity of the edge is perceived is solved by the image processing apparatus 10 is because of an action as follows.

The smoothed image is derived by using the edge-preserving smoothing filter in the image processing apparatus 10. The edge-preserving smoothing filter performs image processing in which the smoothing is not performed in the vicinity of the edge and the smoothing is performed in a region other than the edge (The bilateral filter can be exemplified as the edge-preserving smoothing filter, and this performs weight average operation so as to reduce an influence of pixels, which have a large concentration difference as pixels over the edge have, in the smoothing).

That is, the smoothed image derived by using the edge-preserving filter is an image in which the low frequency component of the image is extracted in the region other than the vicinity of the edge. An area where the low frequency component is extracted depends on a filter size actually used and the like.

The image processing apparatus 10 includes two smoothing units, i.e., the first smoothing unit 20 and the second smoothing unit 30. Both the smoothing units use the edge-preserving filter. The correction data is derived by obtaining a difference between two smoothed images (difference for each pixel), i.e., the first smoothed image derived by the first smoothing unit 20 and the second smoothed image derived by further using the second smoothing unit 30 to the first smoothed image. Therefore, the correction data is an image in which frequency component of a specific range has been extracted in the region other than the vicinity of the edge.

A range in which the frequency range is extracted depends on the filter size used by the first smoothing unit 20 and the second smoothing unit 30, and the like. At this time, in the vicinity of the edge, the edge is preserved and the smoothing is not performed in both the first smoothing unit 20 and second smoothing unit 30. Therefore, cancellation occurs (difference becomes zero) when obtaining difference between two smoothed images. That is, the image processing apparatus 10 can obtain the correction data in which the specific frequency component is extracted in the region other than the vicinity of the edge and values are zero in the vicinity of the edge.

The specific frequency component can be emphasized in the region other than the vicinity of the edge by correcting the input image by using the correction data derived in this way. On the other hand, processing can be performed in which the input image is not corrected in the vicinity of the edge because the correction data becomes zero. That is, the unevenness and the three-dimensional appearance are improved by emphasizing the specific frequency component in the region other than the vicinity of the edge by the image processing apparatus 10. In addition to this, the generated problem in that the emphasis performed in the part, where the concentration change is small, in the vicinity of the edge is perceived can be solved.

The bilateral filter of the image processing apparatus 10 is one form to realize the edge-preserving smoothing filter. The bilateral filter performs the smoothing only in the part where the concentration difference is comparatively small and does not perform the smoothing over the edge part having a large concentration difference. Therefore, it is considered that the bilateral filter is suitable to realize a function to perform the smoothing in the region other than the edge part.

The image processing apparatus 10 responses to a difference of the color components (hue and chroma in addition to the brightness component) in addition to the edge caused by the concentration difference because the edge-preserving smoothing filter used by the first smoothing unit 20 and second smoothing unit 30 is used to the color image.

Therefore, the specific frequency component can be extracted while the influence by the part where the color rapidly changes is removed because the smoothing is not performed in the part where the color rapidly changes. This contributes to suppress the generation of the problem in the part where the color rapidly changes (color change with a sense of incongruity) similar to a sense of incongruity which is felt in the edge part.

Also, the image processing apparatus 10 extracts the specific frequency component contributing to improve the unevenness and the three-dimensional appearance such that the specific frequency component has only the brightness component. The meaning of the extraction regarding only the brightness of the specific frequency component (mainly the low frequency component) is considered as follows.

It is considered that a shadow has a large effect on the unevenness and the three-dimensional appearance of the object (information on the unevenness of the object is transmitted by the shadow). The shadow naturally does not include the color information. Therefore, to use the specific frequency component which does not include the color information is suitable for the purpose to improve the unevenness and the three-dimensional appearance. On the other hand, the comparatively large color change other than the change of the shadow occurs when the correction data (specific frequency component) is added to the input image such that the correction data has the color information. Accordingly, it is not optimal to make the correction data have the color information in a point that the image is converted into the image having the improved unevenness and three-dimensional appearance.

That is, since the two edge-preserving smoothing filters are the smoothing filters to the color image, the image processing apparatus 10 can convert the image into the image having the improved unevenness and three-dimensional appearance while causing no sense of incongruity in the part where the color rapidly changes. Also, by making the derivation of the correction data not have the color information, the shadow which naturally has no color information can be changed without generating the change of the hue and the image can be converted into the image having the improved unevenness and three-dimensional appearance.

First Modification of the Image Processing Apparatus 10

In a first modification of the image processing apparatus 10, a correction data derivation unit 40 calculates correction data by obtaining a difference among components of RGB of RGB data which is not converted without performing color conversion of the first and second smoothed images. The correction data derivation unit 40 of the first modification of the image processing apparatus 10 calculates the correction data by using a formula (10) below.

\vec{h}(x,y)=\vec{g}₁(x,y)−\vec{g}₂(x,y) (10)
\vec{h}(x, y): correction data (three-dimensional vector, respective components correspond to respective colors of RGB)
\vec{g}₁ (x, y): first smoothed image (three-dimensional vector, respective components correspond to respective colors of RGB)
\vec{g}₂(x, y): second smoothed image (three-dimensional vector, respective components correspond to respective colors of RGB)

In the first modification of the image processing apparatus 10, since the correction data includes the color component of the RGB, a calculation formula of a correcting unit 50 is different from that of the image processing apparatus 10. A formula (11) below is a calculation formula to calculate the data after conversion in the correcting unit 50 of the first modification of the image processing apparatus 10.

\vec{f}′(x,y)=\vec{f}(x,y)+\vec{h}(x,y) (11)

\vec{f}′(x, y): image data after conversion

\vec{f}(x, y): input image (image before processing)

\vec{h}(x, y): correction data

In the first modification of the image processing apparatus 10, a specific frequency component can also be emphasized. However, the specific frequency component is independently emphasized regarding each color component of the RGB in the first modification of the image processing apparatus 10. Accordingly, the image can also be converted into the image having improved unevenness and three-dimensional appearance in the first modification of the image processing apparatus 10.

Second Modification of the Image Processing Apparatus 10

A second modification of the image processing apparatus 10 performs gradation conversion processing to correction data, and in addition, adds a V component of an input image to the correction data. A calculation formula (12) below is used in the gradation conversion processing by the second modification of the image processing apparatus 10.

V′_{M}(x,y)=α×V_{M}(x,y) (12)

V′_{M}(x, y): correction data after gradation conversion processing

V_{M}(x, y): correction data before gradation conversion processing

α: gradation conversion parameter (real number)

In the second modification of the image processing apparatus 10, the correction data after the gradation conversion calculated in this way is added to the V component of the input image as indicated by formulas (13) to (15) below.

V′(x,y)=V(x,y)+V′_{M}(x,y) (13)

H′(x,y)=H(x,y) (14)

S′(x,y)=S(x,y) (15)

In the second modification of the image processing apparatus 10, after image data of an HSV color space calculated by the formulas (13) to (15) is converted into a RGB color space, it is output as an image after the processing, similarly to the image processing apparatus 10 and the like.

FIG. 2 is a graph of a conversion characteristic from V_{M}(x, y) to V′_{M}(x, y) (a case where α is 0.5 as a gradation conversion parameter is illustrated in FIG. 2).

As can be understood by the description of the image processing apparatus 10, V_{M}(x, y) has a characteristic to have either a positive value or a negative value as a position of (x, y). Therefore, positive and negative conversions are indicated in FIG. 2 while zero is assumed as a center.

The gradation conversion parameter a can be arbitrarily set by a user in the second modification of the image processing apparatus 10. Accordingly, the user can convert the image into the image having the improved and appropriate unevenness and three-dimensional appearance. According to the study by the inventor, an appropriate range of α (gradation conversion parameter) is about from 0.1 to 1.5 as a specific numerical value.

In the second modification of the image processing apparatus 10, after the gradation conversion processing is performed to the correction data derived by a correction data derivation unit 40, the input image is corrected by adding the correction data to the input image. Therefore, the addition amount to the input image can be adjusted. That is, in a case where the input image is converted into the image having the improved unevenness and three-dimensional appearance, an improvement level (degree) of the unevenness and three-dimensional appearance can be adjusted.

Generally, it is considered that the unevenness and the three-dimensional appearance of a two-dimensional image such as a photo are more improved, the image becomes more preferable. On the other hand, it is not preferable to recreate the unevenness beyond the unevenness of the actual object (object having the unevenness of a medium degree). Therefore, it is most preferable to realize the unevenness and the three-dimensional appearance which are considered to be appropriate by a viewer of the image (a user of an image processing apparatus and the like). However, a method to specify the addition amount, which is considered to be appropriate to realize the appropriate unevenness and three-dimensional appearance of various (unknown) two-dimensional image, to the input image is not established. Therefore, an image processing apparatus, which adjusts the addition amount of the correction data and adds the correction data to the input image, can contribute to find the appropriate unevenness and three-dimensional appearance and adjust the same in the various two-dimensional images.

Third Modification of the Image Processing Apparatus 10

A third modification of the image processing apparatus 10 performs non-linear gradation conversion processing on correction data, and in addition, adds the correction data to a V component of an input image. Calculation formulas (16) and (17) below are used in the gradation conversion processing by the third modification of the image processing apparatus 10.

V′_{M}(x,y)=α×V_{M}(x,y) (case where V_{M}(x,y)≧Vₜₕ) (16)

V′_{M}(x, y): correction data after gradation conversion processing

V_{M}(x, y): correction data before gradation conversion processing

α: gradation conversion parameter (real number)

Vₜₕ: non-linear gradation conversion parameter 2 (real number)

V′_{M}(x,y)=α×Vₜₕ×(V_{M}(x,y)/Vₜₕ)^{β} (case where V_{M}(x,y)≧Vₜₕ) (17)

V′_{M}(x, y): correction data after gradation conversion processing

V_{M}(x, y): correction data before gradation conversion processing

α: gradation conversion parameter (real number)

β: non-linear gradation conversion parameter 1 (real number)

Vₜₕ: non-linear gradation conversion parameter 2 (real number)

In the third modification of the image processing apparatus 10, the correction data after the non-linear gradation conversion calculated in this way is added to the V component of the input image similarly to the second modification of the image processing apparatus 10. In the third modification of the image processing apparatus 10, after the calculated image data of an HSV color space is also converted into a RGB color space, the converted data is output as an image after the processing.

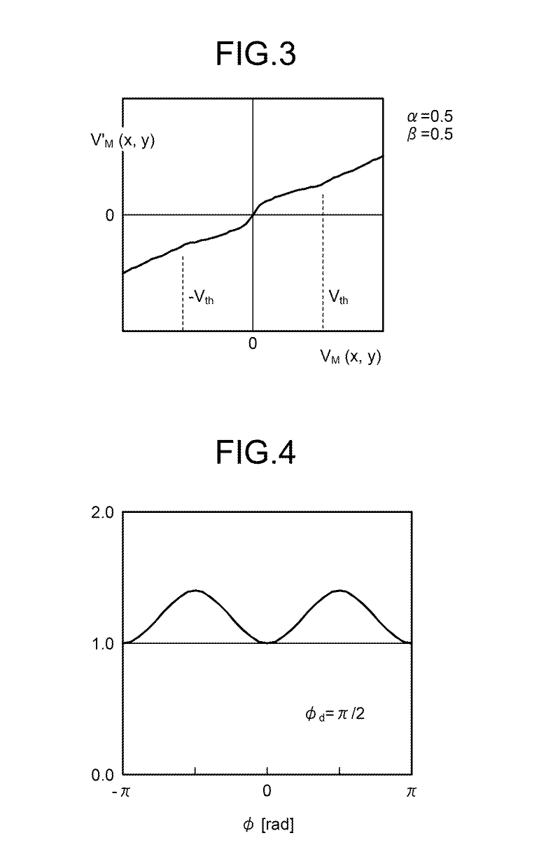

FIG. 3 is a graph of a conversion characteristic from V_{M}(x, y) to V′_{M}(x, y) in a third modification of the image processing apparatus 10 (a case of α: gradation conversion parameter=0.5 and β: non-linear gradation conversion parameter 1=0.5 is illustrated in FIG. 3). V_{M}(x, y) has a characteristic to be able to have either a positive value or a negative value as a position of (x, y). Therefore, the positive and negative conversions are indicated in FIG. 3 while zero is assumed as a center.

According to the study by the inventor, as specific values of various parameters in the third modification of the image processing apparatus 10, a value α is about from 0.1 to 1.5 and a value β is about from 0.5 to 0.9, similarly to the second modification of the image processing apparatus 10. Vth is about from 0.02 to 0.3.

As can be understood by FIG. 3, correction is performed in which an addition amount relatively becomes larger in a range where concentration change is small (a range in the vicinity of zero of a horizontal axis in FIG. 3) by converting the correction data by using the formulas (16) and (17) (by the non-linear gradation conversion processing). Also, the operation to convert the data to be added into the input data can be performed so that the addition amount becomes relatively small in a range where the concentration change is comparatively large (a part far from zero of the horizontal axis in FIG. 3). The above operation is preferable to improve unevenness and three-dimensional appearance of the input image.

Effects below can be obtained by obtaining the data to be added to the input image by performing the non-linear gradation conversion on the correction data as the third modification of the image processing apparatus 10. According to the study by the inventor, it is considered that increase in a contrast by emphasizing the low frequency component in the range where the concentration change is comparatively small (a range where regional contrast, not a whole image, is small) mainly contributes to the improvement in the unevenness and three-dimensional appearance. That is, it is considered that the contrast of what expresses the unevenness of the object is small and thus the unevenness and the three-dimensional appearance of the two-dimensional image can be improved by increasing the contrast to express the unevenness in a part where the contrast to express the unevenness of the object is small within the whole image.

This is because even when the low frequency component in a part where the concentration is large is emphasized, the large contrast has already been added, and therefore, it is expected that the further increase in the contrast by the emphasis be hardly perceived. Accordingly, in order to convert the image into the image having the improved unevenness and three-dimensional appearance, it is preferable to focus on increasing the contrast in the range where the concentration change is comparatively small.

In the third modification of the image processing apparatus 10, the edge-preserving smoothing filter is used. Therefore, the third modification of the image processing apparatus 10 has a characteristic in which the specific frequency component (low frequency component) is not detected (detected as a small value) in the vicinity of a region having a large contrast as an edge. However, even when the concentration change is not concerned as the large concentration difference determined as the edge, the larger the concentration difference, the larger the detected specific frequency component, in a case where the concentration difference is equal to or less than a constant value. This means that the increase in the contrast does not become a preferable increase in the contrast to improve the unevenness and three-dimensional appearance even when the edge-preserving smoothing filter is used. As mentioned above, the preferable increase in the contrast is to intensively increase the contrast in a range where the concentration change is comparatively small.

In the third modification of the image processing apparatus 10, the correction is performed, in which the addition amount becomes relatively large in the above-mentioned range where the concentration change is small, by the non-linear gradation conversion processing. Also, the operation to convert the data to be added to the input data is performed (non-linear gradation conversion is performed) so that the addition amount relatively becomes small in a range where the concentration change is comparatively large (however, the concentration change is not large as the edge). With this operation, for example, the contrast is intensively increased in the above-mentioned range where the concentration change is comparatively small. The contrast can be increased in a preferable form in the improvement in the unevenness and three-dimensional appearance.

That is, the contrast can be intensively increased in the range where the concentration change is comparatively small in the third modification of the image processing apparatus 10. On the other hand, the third modification of the image processing apparatus 10 can suppress the contrast with small necessity in the range where the concentration change is comparatively large in improving the unevenness and the three-dimensional appearance.

Fourth Modification of the Image Processing Apparatus 10

In anisotropic emphasis processing performed in the fourth modification of the image processing apparatus 10, the discrete Fourier transform is performed to correction data V_{M}(x, y) first before conversion processing. Next, the correction data after the conversion is calculated by emphasizing a spatial frequency component for what having a spatial frequency close to a specific direction and thereafter performing inverse discrete Fourier transform. A user specifies the specific direction. A calculation formula used in the fourth modification of the image processing apparatus 10 will be described below.

The discrete Fourier transform is performed to the correction data V_{M}(x, y) before the conversion processing, and the result is spatial frequency spectrum η_{M}(u, v). The spatial frequency spectrum η_{M}(u, v) is calculated by a formula (18) below.

$${η}_{M} ( u , v ) = {\sum }_{x = 0}^{M - 1} {\sum }_{y = 0}^{N - 1} {V}_{M} ( x , y ) {e}^{- 2 π i ( \frac{ux}{M} + \frac{vy}{N} )} \\ u = 0 , … , M - 1 ; v = 0 , … N - 1 \qquad ( 18 )$$

Here, values M and N respectively express the numbers of the pixels (M, N) in x and y directions in the correction data V_{M}(x, y).

Next, a spatial frequency vector is calculated by using a formula (19) below.

$$spatial frequency vector \vec{k} \\ \vec{k} = ( {k}_{x} , {k}_{y} ) \\ \begin{matrix}{k}_{x} = u / M \times R / 25.4 ( case where u \leq M / 2 ) \\ = ( M - u ) / M \times R / 25.4 ( case where u > M / 2 ) \\ {k}_{y} = v / N \times R / 25.4 ( case where v \leq N / 2 ) \\ = ( N - v ) / N \times R / 25.4 ( case where v > N / 2 )\end{matrix} \qquad ( 19 )$$

A value R in the formula (19) is resolution of the correction data V_{M}(x, y) and is same as resolution of an input image. In the fourth modification of the image processing apparatus 10, the resolution of the input image is 400 [dpi]. The numeral “25.4” in the formula (19) is based on a fact that one inch corresponds to 25.4 mm. Therefore, a unit of the spatial frequency calculated according to the formula (19) becomes [cycle/mm]. However, only a ratio between an x component and a y component of the spatial frequency vector is used in the fourth modification of the image processing apparatus 10. Therefore, even when a value of the resolution is not the same as the above, or when the unit of the spatial frequency is other than [cycle/mm], the result does not change.

In the fourth modification of the image processing apparatus 10, anisotropic emphasis processing is performed to the spatial frequency spectrum calculated according to the formula (19). Specifically, the spatial frequency component η′_{M}(u, v) after the anisotropic emphasis is calculated according to formulas (20) and (21) below.

η′_{M}(u,v)=(1.0+(0.2+0.2×cos(2(φ−φ_{d}))))×η_{M}(u,v) (20)
η′_{M}(u, v): spatial frequency component after anisotropic emphasis has been performed
η_{M}(u, v): spatial frequency component before emphasis
φ_{d}: direction having larger emphasis amount when anisotropic emphasis is performed (set by user)
φ: real number for satisfying formula below (calculated from index of spatial frequency (u, v) and number of pixels of correction data (M, N))

$$( \begin{matrix}{k}_{x} \\ {k}_{y}\end{matrix} ) = \sqrt{{k}_{x}^{2} + {k}_{y}^{2}} ( \begin{matrix}sin φ \\ cos φ\end{matrix} ) \\ 0 \leq φ < 2 π \qquad ( 21 )$$

In the fourth modification of the image processing apparatus 10, the spatial frequency component is emphasized so that emphasis amount becomes larger in a direction of φ_{d} according to the formula (20). FIG. 4 is a graph of coefficients in the formula (20). FIG. 4 represents a case where φ_{d}=π/2. In the fourth modification of the image processing apparatus 10, the frequency component after the emphasis is calculated by obtaining a product of a coefficient having different emphasis amount with respect to each direction with each frequency component as can be understood by FIG. 4.

In fourth modification of the image processing apparatus 10, the inverse discrete Fourier transform (inverse DFT) is performed to η′_{M}(u, v) which has generated by performing the anisotropic emphasis processing in this way. Then, the correction data V′_{M}(x, y) after the emphasis is calculated. A calculation formula of V′_{M}(x, y) is a formula (22).

$${V}_{M}^{′} ( x , y ) = \frac{1}{MN} {\sum }_{u = 0}^{M - 1} {\sum }_{v = 0}^{N - 1} {η}_{M}^{′} ( u , v ) {e}^{2 π i ( \frac{ux}{M} + \frac{vy}{N} )} \\ u = 0 , … , M - 1 ; v = 0 , … N - 1 \qquad ( 22 )$$

The correction data, to which the anisotropic emphasis processing is performed, calculated in the fourth modification of the image processing apparatus 10 in this way is added to the V component of the input image according to the formulas (23) to (25) below similarly to the image processing apparatus 10.

V′(x,y)=V(x,y)+V′_{M}(x,y) (23)

H′(x,y)=H(x,y) (24)

S′(x,y)=S(x,y) (25)

In the fourth modification of the image processing apparatus 10, the corrected data is added to the V component of the input image according to the formulas (23) to (25). However, the corrected data to which the anisotropic emphasis processing has been performed may be added after the gradation conversion processing is further performed thereto as the second modification of the image processing apparatus 10. Also, the correction data may be added after the non-linear gradation conversion processing is performed thereto as the third modification of the image processing apparatus 10.

In the fourth modification of the image processing apparatus 10, after the image data of an HSV color space is converted into a RGB color space, the converted image data calculated by the formulas (23) to (25) is output as an image after the processing. In the fourth modification of the image processing apparatus 10, the anisotropic emphasis is performed by a method in which the anisotropic emphasis is performed to the spatial frequency component after the discrete Fourier transform has been performed to the correction data. However, this is only one method to realize the anisotropic emphasis, and the anisotropic emphasis may be realized by other methods. For example, the anisotropic emphasis may be performed by performing an anisotropic filter (convolution) to the correction data.

In the fourth modification of the image processing apparatus 10, the unevenness and the three-dimensional appearance of the image data are further improved by adding the correction data to the input image after the anisotropic emphasis processing has been performed to the correction data. Therefore, the improvement in reality (sense of presence) of the image data can be achieved. That is, the image data can be converted into the image in which the larger unevenness and three-dimensional appearance can be felt by the anisotropic emphasis.

According to the study by the inventor, the reason why the unevenness and the three-dimensional appearance are further improved by performing the anisotropic emphasis to the correction data as the fourth modification of the image processing apparatus 10 has not necessarily become apparent. However, the inventor considers it as follows. It is considered that the unevenness and the three-dimensional appearance are caused by a place and shape of the shadow in the image. However, since the shadow of the object generated by a lighting has directivity, it is considered that the shadow is efficiently emphasized by increasing the contrast of the image (especially, low frequency component) in a direction of the shadow. Therefore, it is considered that the “shadow” in the image data changes to the “shadow” having the larger unevenness and three-dimensional appearance by performing the anisotropic emphasis processing to the correction data as the fourth modification of the image processing apparatus 10. It is considered that the increase in the unevenness and three-dimensional appearance becomes large as a result.

Also, a function almost same as this anisotropic emphasis can be realized by performing anisotropic smoothing by the edge-preserving smoothing filter used in a case where the correction data is calculated. However, the edge-preserving smoothing filter generally has a large calculation load and takes longer calculation time. Therefore, in a case where a direction to which a larger emphasis is performed is changed (direction is changed), it is inadvisable in terms of a calculation amount to apply the edge-preserving smoothing filter and calculate again.

Regarding this point, the fourth modification of the image processing apparatus 10 has used an isotropic edge-preserving smoothing filter, and the correction data has been derived. Then, the anisotropic emphasis processing is performed to the correction data as necessary. In the fourth modification of the image processing apparatus 10, it is necessary to make the edge-preserving smoothing filter having the large calculation amount perform only once. However, it is not necessary to apply the edge-preserving smoothing filter which takes long calculation time and calculate again when the direction to which the larger emphasis is performed is changed. Therefore, the image processing in which the calculation time does not become longer when the emphasis direction is changed can be realized.

That is, in the fourth modification of the image processing apparatus 10, since the contrast of the concentration change caused by the shadow of the object can be increased, the image processing apparatus which can convert the image into the image having the improved unevenness and three-dimensional appearance is realized. Also, the image processing apparatus having a short calculation time even when the direction to which the larger emphasis is performed is changed is realized.

Fifth Modification of the Image Processing Apparatus 10

A fifth modification of the image processing apparatus 10 realizes a same function as the first modification of the image processing apparatus 10 by performing filter processing only once. The filter processing performed in the fifth modification of the image processing apparatus 10 is performed by using calculation formulas (26) and (27) below. Similarly to the first modification of the image processing apparatus 10 and the like, since an image data is two-dimensional image data, a position coordinate of each pixel is expressed by x and y. Also, since the input image is a color image having three color components of RGB in each pixel, the input image is expressed as a three-dimensional vector.

$$\vec{h} ( x , y ) = {k}^{- 1} {\sum }_{n = - w}^{w} {\sum }_{m = - w}^{w} \vec{f} ( x + m , y + n ) \times ( exp [ - \frac{{m}^{2} + {n}^{2}}{2 {σ}_{11}^{2}} ] - exp [ - \frac{{m}^{2} + {n}^{2}}{2 ( {σ}_{11}^{2} + {σ}_{12}^{2} )} ] ) \times exp [ - \frac{{\vert \vec{f} ( x + m , y + n ) - \vec{f} ( x , y ) \vert}^{2}}{2 {σ}_{2}^{2}} ] \qquad ( 26 )$$

x, y: x-coordinate and y-coordinate for representing pixel position of two-dimensional image data (integer number)
m, n: x-coordinate and y-coordinate for representing filter position (integer number)
W: maximum and minimum values of the above-mentioned m and n (filter size becomes 2W+1)
\vec{h}(x, y): correction data (h is three-dimensional vector and respective components of vector correspond to RGB values which represent three color components of color image)
\vec{f}(x, y): value in position of input image (image before processing) (x, y) (f is three-dimensional vector and respective components of vector correspond to RGB values which represent three color components of color image)
   |\vec{f}(x+m, y+n)−\vec{f}(x, y)|²: square of absolute value of vector difference (sum of squares of differences of respective components of vector)
σ₁₁: standard deviation 11 (value for characterizing weighting by distance in x and y directions and corresponding to standard deviation 1: σ₁ of the first smoothing unit)
σ₁₂: standard deviation 12 (value for characterizing weighting by distances in x and y directions and corresponding to standard deviation 1: σ₁ of the second smoothing unit)
σ₂: standard deviation 2 (value for characterizing weighting by distance between colors)
k: term to make a sum of each weight by smoothing 1 (average values of \vec{g}(x, y) and \vec{f}(x, y) becomes constant)

$$k = {\sum }_{n = - w}^{w} {\sum }_{m = - w}^{w} ( exp [ - \frac{{m}^{2} + {n}^{2}}{2 {σ}_{11}^{2}} ] - exp [ - \frac{{m}^{2} + {n}^{2}}{2 ( {σ}_{11}^{2} + {σ}_{12}^{2} )} ] ) \times exp [ - \frac{{\vert \vec{f} ( x + m , y + n ) - \vec{f} ( x , y ) \vert}^{2}}{2 {σ}_{2}^{2}} ] \qquad ( 27 )$$

In the first smoothing unit 20 of the fifth modification of the image processing apparatus 10, a value of 30[pixel] is used as a value of the above-mentioned standard deviation σ11, a value of 90[pixel] is used as a value of the standard deviation σ12, and a value of 0.2 is used as a value of the standard deviation σ2. These are the same values as the values described in the first modification of the image processing apparatus 10. The values which are not mentioned other than the above values are set to be the same as those in the first modification of the image processing apparatus 10, and then the calculation is performed.

A calculation method used by the image processing apparatus 10 may have a problem in that calculation amount and time become larger and longer at the time of a convolution calculation with an edge-preserving smoothing filter. The fifth modification of the image processing apparatus 10 copes with these situations. The calculation of the convolution part to be a point of the calculation amount and time can be performed only once. Accordingly, in the fifth modification of the image processing apparatus 10, the function equivalent to the first modification of the image processing apparatus 10 can be realized while the calculation amount and time are reduced.

### Second Embodiment

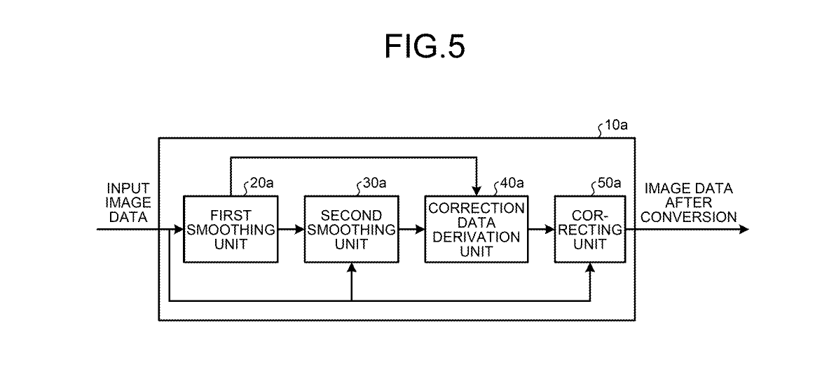

FIG. 5 is a block diagram of a configuration of an image processing apparatus 10a according to a second embodiment. First, an outline of the image processing apparatus 10a will be described. As indicated in FIG. 5, the image processing apparatus 10a includes a first smoothing unit 20a, a second smoothing unit 30a, a correction data derivation unit 40a, and a correcting unit 50a. A characteristic of the image processing apparatus 10a is that the second smoothing unit 30a performs processing to an input image itself. Each part of the image processing apparatus 10a may include hardware and software executed by a CPU not illustrated.

The image processing apparatus 10a receives general-purpose image data (input image data) as the input image. The first smoothing unit 20a has a function similar that of the first smoothing unit 20. A calculation formula itself used by an edge-preserving smoothing filter of the second smoothing unit 30a is the above-mentioned bilateral filter. However, a value of a parameter to be used is set to be a value as follows in the image processing apparatus 10a.

The second smoothing unit 30a uses 95 [pixel] as a value of a standard deviation σ1, and an appropriate range of the value of the standard deviation σ1 is from 47 to 190 [pixel]. A reason why such a range is appropriate is similar to the image processing apparatus 10 and will be described as follows.

By setting the value of the standard deviation σ1 of the second smoothing unit 30a in the above-mentioned range (47 to 190 [pixel]), the image processing apparatus 10a can remove a spatial frequency component corresponding to a spatial frequency smaller than 0.1 [cycle/mm] in rough estimation when it is assumed that a resolution of the input image be 400 dpi. Therefore, the image processing apparatus 10a can extract a component in a target frequency region as the specific frequency component by obtaining a difference between an image to which the processing is performed by the second smoothing unit 30a and a first smoothed image.

An appropriate range of the value of the standard deviation σ1 used by the second smoothing unit 30a of the image processing apparatus 10a is a range of 47 to 190 [pixel] which is slightly larger than that of the image processing apparatus 10. This is because it is necessary to perform the smoothing (blur the image) in a wider range in the second smoothing unit 30a of the image processing apparatus 10a (This is because, since the image processing apparatus 10 performs the smoothing of the image twice, i.e., once in the first smoothing unit 20 and once in the second smoothing unit 30, the smoothing can be performed to the input image in the wide range even when the value of the standard deviation σ2 in the second smoothing unit 30 is small).

Another configuration of the image processing apparatus 10a is similar to that of the image processing apparatus 10. The correction data derivation unit 40a obtains a difference (correction data) between the first and second smoothed images by a method similar to that of the correction data derivation unit 40. The correcting unit 50a calculates an output image by adding the calculated correction data to the input image.

In the image processing apparatus 10a, first and second smoothing processing are independent from each other (each processing does not depend on processing result of the other processing). Therefore, the calculation can be parallelized. Generally, a calculation with edge-preserving smoothing filter processing takes long time. Therefore, with a configuration in which the edge-preserving smoothing filter processing is performed twice, a period of time required to calculate becomes significantly large. Therefore, since the calculation having a large processing load can be performed in parallel by the image processing apparatus 10a, the calculation time can be shortened.

There has been a problem in that the calculation load becomes large and the calculation time becomes long by using the edge-preserving smoothing filter. However, the image processing apparatus 10a can realize shortening of the calculation time by the parallelization in addition to the effects of the image processing apparatus 10. That is, the calculation time does not become longer when the input image is converted into the image having the improved unevenness and three-dimensional appearance.

The image processing apparatus 10a indicated in the second embodiment may be combined with each modification of the image processing apparatus 10 indicated in the first embodiment.

According to an embodiment, an effect to improve the unevenness and the three-dimensional appearance of the image can be obtained even when the plurality of lightings exists with respect to the image.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
a first smoothing unit that outputs a first smoothed image by using a first edge-preserving smoothing filter to an input image;
a second smoothing unit that outputs a second smoothed image by further using a second edge-preserving smoothing filter to the first smoothed image output by the first smoothing unit;
a correction data derivation unit that derives a difference between the first and second smoothed images as correction data; and
a correcting unit that corrects the input image based on the correction data.

2. The image processing apparatus according to claim 1, wherein
the correcting unit corrects the input image by adding the correction data to the input image.

3. The image processing apparatus according to claim 2, wherein
the correcting unit adds the correction data to which gradation conversion processing has been performed, to the input image.

4. The image processing apparatus according to claim 3, wherein
the gradation conversion processing is non-linear gradation conversion processing.

5. The image processing apparatus according to claim 2, wherein
the correcting unit adds the correction data to which anisotropic emphasis processing has been performed, to the input image.

6. The image processing apparatus according to claim 1, wherein
both the first and second edge-preserving smoothing filters are bilateral filters.

7. The image processing apparatus according to claim 1, wherein
the first and second edge-preserving smoothing filters perform edge-preserving smoothing processing on a color image, and
the correction data derivation unit derives a difference between a brightness component of the first smoothed image and a brightness component of the second smoothed image as the correction data.

8. An image processing apparatus comprising:
a first smoothing unit that outputs a first smoothed image by using a first edge-preserving smoothing filter to an input image;
a second smoothing unit that outputs a second smoothed image by using a second edge-preserving smoothing filter that performs smoothing in a wider range than the first edge-preserving smoothing filter, to the input image;
a correction data derivation unit that derives a difference between the first and second smoothed images as correction data; and
a correcting unit that corrects the input image based on the correction data.

9. The image processing apparatus according to claim 8, wherein
the correcting unit corrects the input image by adding the correction data to the input image.

10. The image processing apparatus according to claim 9, wherein
the correcting unit adds the correction data to which gradation conversion processing has been performed, to the input image.

11. The image processing apparatus according to claim 10, wherein
the gradation conversion processing is non-linear gradation conversion processing.

12. The image processing apparatus according to claim 9, wherein
the correcting unit adds the correction data to which anisotropic emphasis processing has been performed, to the input image.

13. The image processing apparatus according to claim 8, wherein
both the first and second edge-preserving smoothing filters are bilateral filters.

14. The image processing apparatus according to claim 8, wherein
the first and second edge-preserving smoothing filters perform edge-preserving smoothing processing on a color image, and
the correction data derivation unit derives a difference between a brightness component of the first smoothed image and a brightness component of the second smoothed image as the correction data.
